(19) United States
(12) Patent Application Publication
(10) Pub. No.: US 2007/0265936 A1
(43) Pub. Date: Nov. 15, 2007

(54) NETWORK MARKETING AND PAYMENT-BREAKDOWN METHOD

(75) Inventors: Yun-Chung Chang, Taipei (TW); Yung-Hung Huang, Taipei (TW); Liang-Yi Lai, Taipei (TW)

Correspondence Address: SAWYER LAW GROUP LLP, P O BOX 51418, PALO ALTO, CA, 94303, US

(73) Assignee: AUROTEK CORPORATION, Taipei (TW)

(21) Appl. No.: 11/746,725

(22) Filed: May 10, 2007

(30) Foreign Application Priority Data
May 10, 2006 (TW) 095116672
May 10, 2007 (TW) 95109420

(51) Int. Cl. G06Q 30/00

(52) U.S. Cl. 705/26

(57) ABSTRACT

A network marketing and payment-breakdown method is proposed to allow website marketers to build a personalized learning platform or a commodity marketing platform, the method being implemented by configuring a network marketing platform that allows a plurality of marketing users to register and become website marketers for selling products or services through websites; allowing the plurality of website marketers to register with the network marketing platform to establish their own exclusive personalized marketing websites, so as to place commodities to be sold on self-marketing personalized websites; interconnecting the self-marketing personalized websites for cross-marketing with one another for selling commodities via a network connection function; and breaking down payments for sold commodities or rendered services to relevant website marketers according to the sources for the commodities or services after transactions are completed by payments.

### CROSS REFERENCE TO RELATED APPLICATIONS

Under 35 U.S.C. 119(e), this application claims the benefit of priority to Taiwanese Patent Application No. 095116672, filed May 10 200795109420, filed May 10, 2007, all of which is incorporated herein by reference.

### BACKGROUND OF THE INVENTION

1. Field of the Invention

The present invention relates to network marketing techniques, and more particularly, to a network marketing and payment-breakdown method capable of interconnecting personalized marketing websites with one another to increase the exposure rate of the marketing products or services, and thereafter break down the payments obtained from selling products or providing services.

2. Description of Related Art

With the rapid development of the Internet, network marketing has become an in-dispensable marketing means. The establishment of websites on servers allows companies and enterprises to engage in all sorts of commercial activities, such as running advertise-ments for their products, placing orders with suppliers, and making procurements of required items via the Internet, effectively solving many of the drawbacks of traditional commercial means in which manpower and resources were traditionally required. As such, many websites have emerged that take advantage of the convenience of electronic commerce, allowing people to publicize their products on websites and use so-called superlinks to positively increase the exposure rate of their products and increase sales vol-ume.

However, the efforts to promote and market products and services through websites often falls short because, although visitors often use websites to search and obtain the information they require, they don't often use them to seek information peculiar to commercial activities that are vast and unorganized due to the difficulty in isolating the desired information.

Therefore, creating an effective way to provide fast marketing and recommendation of products and services via the Internet to increase the rate of exposure and sales is a desirable goal in the industry.

### SUMMARY OF THE INVENTION

The present invention aims to eliminate the aforementioned drawbacks, and, as such, a primary objective of the present invention is to provide a network marketing and payment-breakdown method applicable to a network marketing platform that can effectively take advantage of a fast and convenient network system to achieve the objective of rapid and effective recommendation and marketing of goods or services.

Another objective of the present invention is to provide a network marketing and payment-breakdown method applicable to a network marketing platform that allows registered website marketers having their own personalized marketing websites to be able to self-manage and control websites and also receive accounts of payments for marketing or selling commodities or services through the network, and that further allows interconnection in real-time with other personalized marketing websites, thereby marketing and selling commodities or services to one another to significantly increase sales volume, in other words, to effectively increase the rate of exposure and sale of the recommended goods or services.

In order to achieve the above and other objectives, the present invention provides a network marketing and payment-breakdown method, comprising the steps of: (1) configuring a network marketing platform having an automatic registering function for allowing website marketers to self-manage such website and visitor transactions; (2) allowing a plurality of website marketers to register with the network marketing platform to establish their own exclusive personalized marketing websites so as to place commodities to be sold on their self-marketing personalized websites, wherein the commodity to be sold can be an intangible entity such as a network learning course, a package tour, or an insurance service product, or a tangible article; (3) opening the self-marketing personalized website for Internet visitors to browse the contents of the websites; and (4) providing the function of network connection in real-time for allowing personalized websites having the same or similar marketing goods or services to interconnect with one another, so as to increase the exposure rate of the goods and services, and further, after the purchase of a commodity or service is completed by payment, the network marketing platform splits the payment for the purchased goods or service to relevant website marketers according to a payment-breakdown method based on the sources of the commodity or service.

In summary, the network marketing and payment-breakdown method of the present invention provides notable advantageous over the prior arts in that it allows website marketers to be able to self-establish a personalized learning platform or a commodity marketing platform in addition to carrying general advertisements and photos on the website, to directly manage visitor transactions and collect payments for sold commodities, to market and sell products or services to other website marketers having the same or similar products or services by means of member account management and network real-time connection functions provided by the invention, so as to increase the volume of sales by cross-marketing to acquire marketing commissions associated with such sales, thereby effectively marketing the products or services by taking advantage of the fast and convenient characteristics of network marketing, enhancing the function and value of conventional personalized websites as a result.

### BRIEF DESCRIPTION OF DRAWINGS

These and other objects and advantages of the present invention shall become more apparent from the accompanying drawings and description thereof. The accompanying drawings, which are incorporated in and constitute a part of this specification, illustrate embodiments of the invention and serve to explain the details of the preferred embodiments, in which:

FIG. 1 is a logic flow diagram illustrating the steps of implementing the network marketing and payment-breakdown method, from establishing a network marketing platform to payment breakdown after a transaction is completed, in accordance with the principles of the invention;

FIG. 2 is a block diagram illustrating the actual operation of product-selling and payment breakdown in accordance with the network marketing and payment-breakdown method of the invention; and

FIG. 3 is a diagram illustrating a website picture of an editing course in accordance with the principles of the invention.

### DETAILED DESCRIPTION OF PREFERRED EMBODIMENT

The present invention is described in the following so that one skilled in the pertinent art can easily understand other advantages and effects of the present invention. The present invention may also be implemented and applied according to other embodiments, and the details may be modified based on different views and applications without departing from the spirit of the invention.

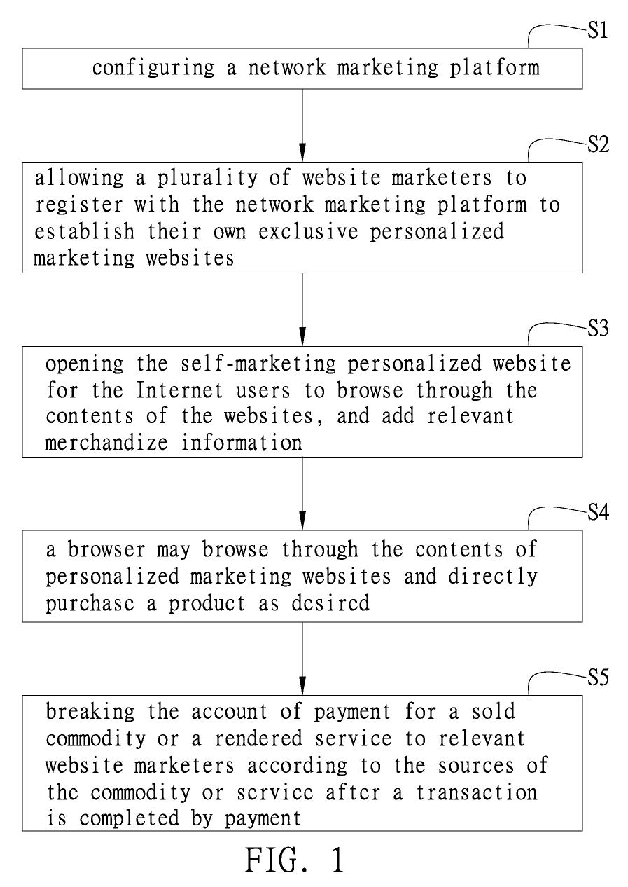

FIG. 1 is a flow diagram illustrating the steps of implementing the network marketing and payment-breakdown method, from establishing a network marketing platform to payment breakdown after a transaction is completed, in accordance with the invention. As shown, step S1 is executed to configure a network marketing platform which can be provided by information companies that allows website marketers registered with the network marketing platform to directly collect their share of payments from selling products or services after individually breaking down such payments, the network marketing platform being equipped with the functions of automatic registration, account management, and network real-time connection. Then, step S2 is executed.

In step S2, marketers are instructed to register with the network marketing platform so as to establish exclusive personalized marketing websites and become website marketers who can market their products via the Internet websites. The information company which configures the platform may charge the applicants some basic fees such as member fees, storage-space fees, and handling fees, and website marketers can build a personalized learning platform by themselves by means of the automatic registration function provided by the network marketing platform. Then, step S3 is executed.

In step S3, network marketers may display their commodities to be sold on the self-marketing personalized websites, add related commodity information, and use the function of account management provided by the network marketing platform to directly manage web visitors, as well as collect their share of payments after breaking down payments; in addition, the function of real-time network connection provided by the network marketing platform allows personalized websites having the same or similar marketing goods or services to interconnect with one another, so as to increase the exposure rate of the goods or services. Thereafter, step S4 is executed.

In step S4, website visitors may browse the contents displayed on the personalized marketing websites and directly purchase, for example, a specific course or a commodity as desired. Next, step S5 is executed.

In step S5, after completing a transaction and receiving the payment, the network marketing platform proceeds to breakdown the payment obtained from selling a commodity or service based on a predetermined ratio of commission according to the path of registration of the sold commodity or service, or the original supplier (including the final website and other, intermediate website marketers or members of personalized marketing websites), and assign the proportion of the payment after breaking down the payment to the website marketer who sold a product or service.

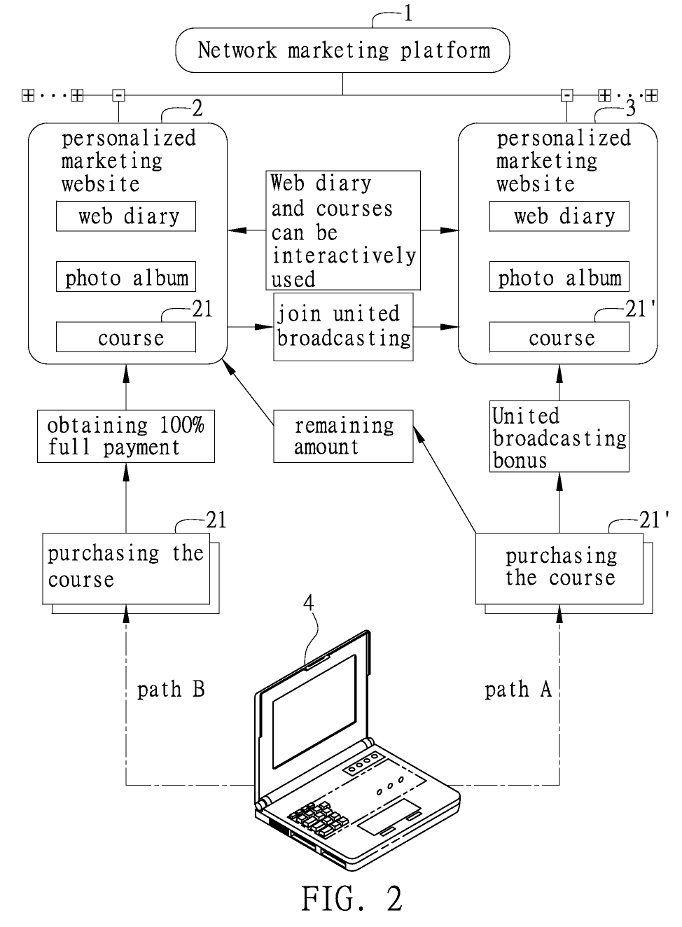

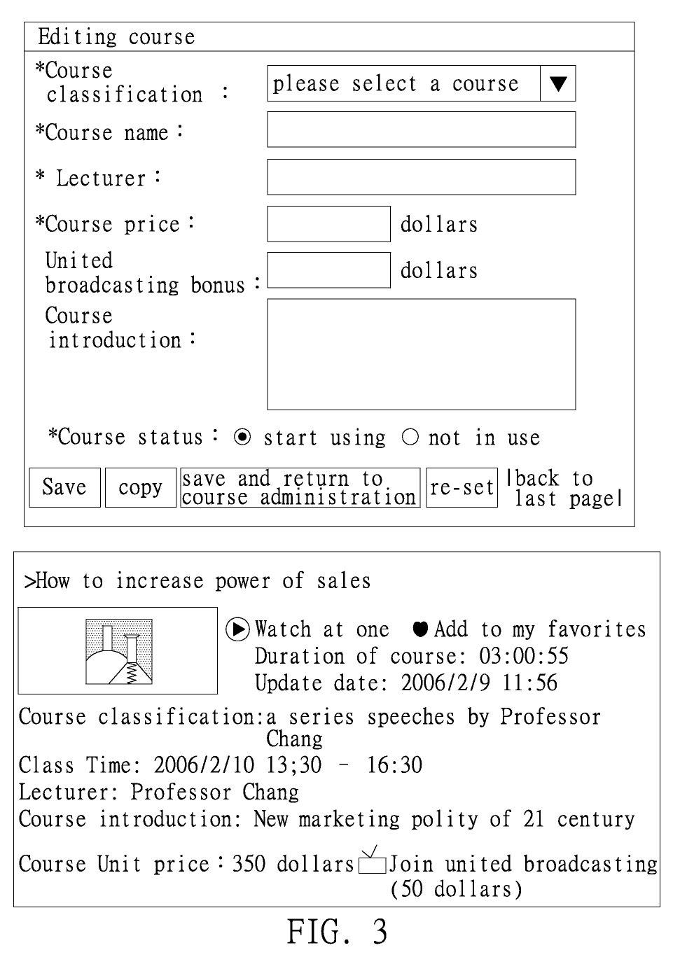

FIG. 2 is a block diagram illustrating the actual operation of a product-selling and payment-breakdown in accordance with the network marketing and payment-breakdown method of the invention. As shown in the drawing, a plurality of marketing users register with the network marketing platform 1 to become network marketers of a personalized marketing website 2 and a personalized marketing website 3. For example, the network marketer of the personalized marketing website 2 presents a new course 21 on the website; inputs basic data relating to the sales price of the course 21, the united broadcasting commission (as shown in FIG. 3) to be shared, and the product to be sold (i.e. the course 21), so as to make the product available for purchase to the public. After the publication of the course 21, if the network marketer of the personalized marketing website 3 is interested in marketing the course 21 provided by the personalized marketing website 2, the marketer can join a united broadcasting procedure to include the course 21 into his/her own personalized marketing website (as shown in FIG. 2, the personalized marketing website 3 adds a new course 21′). Thereafter, when a user visits and browses the contents of the personalized marketing website 3 and is interested in the course of 21′ (path A) and has completed the payment procedure, the website marketer of the personalized marketing website 3 can acquire the united broadcasting commission for the course 21 provided by the website marketer of the personalized marketing website 2 at a predetermined commission, and the website marketer of the personalized marketing website 2 can obtain the share of the payment after deducting the united broadcasting bonus (payment-breakdown commission); conversely, if a website visitor directly purchases the course 21 (path B) from the personalized marketing website 2, the website marketer of the personalized marketing website 2 can receive full payment for the course 21 without paying a commission amount to a third party.

Many personalized marketing websites such as blogs, families, groups or discussion talks have emerged and become commonplace. For instance, websites with blogs can provide visual variety and are gaining popularity due to the characteristics of collecting and organizing, connecting, time stamping and date titling. As a result, it encourages many websites and Internet Service Providers (ISP) to provide related services with respect to personalized marketing websites for applications, maintenance and management. Therefore, the network marketing and payment breakdown of the invention is implemented through the personalized marketing websites to achieve the objective of fast and effective recommendation and marketing of products or services so as to increase sales volume, thereby enhancing the function and value of conventional personalized websites consequently.

Further, the network marketing and payment-breakdown method of the invention also features using a personalized learning platform or a commodity selling platform established by the personalized marketing website to interconnect other personalized marketing websites having the same or similar attributes for cross-marketing so as to acquire sales commissions from marketing products or services of others. Also, it can increase the function and value of the existing personalized marketing websites that merely act as a medium for acquiring information and sharing life experiences of the author.

The invention has been described using exemplary preferred embodiments. However, it is to be understood that the scope of the invention is not limited to the disclosed embodiments. On the contrary, it is intended to cover various modifications and similar arrangements. For example, the commodity to be sold could a tangible article or an intangible entity such as a learning course, a package tour, or an insurance product, and the network marketing platform could establish a network connection with banks via a network system (such as the Internet), allowing the sales amount of a product to be split and assigned to related website marketers by registering with an information company or a bank; moreover, commodity information can be browsed by browsers of other websites, and the commodity sales price to be split can be set by network marketers of personalized marketing websites, suppliers of commodities, or manufacturers of commodities depending on the application. The scope of the claims, therefore, should be accorded the broadest interpretation so as to encompass all such modifications and similar arrangements.

What is claimed is:

1. A network marketing and payment-breakdown method, comprising:
configuring a network marketing platform for allowing website marketers to self-manage websites and process the transactions of website visitors;
allowing a plurality of website marketers to register with the network marketing platform to establish their own exclusive personalized marketing websites, so as to place commodities to be sold on the self-marketing personalized websites,
opening the self-marketing personalized websites for Internet visitors to browse through the contents of the websites; and
breaking each payment down for a sold commodity or a rendered service to relevant website marketers according to the sources of the commodity or service after a transaction is completed by payment.

2. The network marketing and payment-breakdown method according to claim 1, wherein the commodity to be sold can be one of a network learning course, a package tour, an insurance service product, and tangible articles.

3. The network marketing and payment-breakdown method according to claim 1, wherein the network marketing platform comprises an automatic registering function to enable website marketers to build a personalized learning platform.

4. The network marketing and payment-breakdown method according to claim 1, wherein the account management function is adapted to manage and control website browsers and collect payment when a browser purchases a product or a service rendered.

5. The network marketing and payment-breakdown method according to claim 1, wherein the network marketing platform further comprises a function of network connection in real-time for allowing personalized websites having the same or similar market goods or services to interconnect with one another, so as to increase the exposure rate of the goods and services.

6. The network marketing and payment-breakdown method according to claim 1, wherein the website marketer determines the percentage amount of payments to be shared and split between relevant personalized website marketers after selling a commodity or rendering a service.

7. The network marketing and payment-breakdown method according to claim 1, wherein the website marketing platform is constructed by an information company and connected with banking systems through the Internet, thereby allowing the step of payment breakdown between relevant website marketers after selling a commodity or rendering a service to be executed by registering with the information company or a bank.

8. The network marketing and payment-breakdown method according to claim 1, wherein the merchandize information provided by the website marketing platform can be browsed by browsers of other websites.
